(19) United States
(12) Patent Application Publication
(10) Pub. No.: US 2008/0017679 A1
(43) Pub. Date: Jan. 24, 2008

(54) ROOF BOX FOR A VEHICLE

(76) Inventors: Philippe LEBLANC, Montreal (CA); Stephan DEMERS, Laval (CA); Elaine DESJARDINS, Montreal (CA)

Correspondence Address: FISH & RICHARDSON P.C., P.O. BOX 1022, MINNEAPOLIS, MN, 55440-1022, US

(21) Appl. No.: 11/458,415

(22) Filed: Jul. 19, 2006

(51) Int. Cl. B60R 9/00; B60R 9/055

(52) U.S. Cl. 224/328; 224/315; 224/319

(57) ABSTRACT

A roof box comprising: (a) a bottom part comprising a bottom section and side sections projecting upwardly from the bottom section, the bottom section being adapted for mounting the roof box to a roof area of a vehicle; (b) a top part movable relative to the bottom part between an opened position and a closed position, the top part comprising a top section and side sections projecting downwardly from the top section, wherein, in the closed position, the bottom section and the side sections of the bottom part and the top section and the side sections of the top part define an internal volume for storing objects in the roof box, the top part comprising first and second polymeric walls joined together at the side sections of the top part to define an interior space between the first and second polymeric walls; and (c) at least one strengthening element provided in the top section of the top part, each strengthening element being made of a respective portion of the first polymeric wall fused to a corresponding portion of the second polymeric wall and extending longitudinally along the roof box.

### FIELD OF THE INVENTION

The present invention relates to vehicle roof boxes for storing luggage, cargo and/or other objects (e.g., sporting equipment).

### BACKGROUND

A roof box for a vehicle is a container mountable to a roof area of the vehicle and adapted to store luggage, cargo and/or other objects (e.g., sporting equipment). Typically, the roof box comprises a bottom part for mounting to the roof area of the vehicle and a top part movable relative to the bottom part for opening and closing the roof box. Such a roof box is often preferred over an open roof rack since it protects objects stored therein against exposure to adverse weather and environment conditions (e.g., wind, rain, snow, UV radiation, etc.) and against theft and/or vandalism.

For some existing roof boxes, each of the bottom part and the top part comprises a structure of polymeric material thermoformed using a blow molding process. In order to enhance strength and rigidity characteristics of these roof boxes, reinforcing metallic inserts are sometimes introduced in an interior space defined by the structure of polymeric material. This introduction of strengthening metallic inserts complicates manufacturing of these roof boxes.

Also, existing roof boxes provide a storage volume that is typically fixed and incapable of adaptation to accommodate different storage requirements.

There is therefore a need for improvements directed to enhancement of strength and rigidity characteristics of vehicle roof boxes. There is also a need for improvements directed to enhancing adaptability of storage volumes of vehicle roof boxes to accommodate different storage requirements.

### SUMMARY OF THE INVENTION

As embodied and broadly described herein, the invention provides a roof box comprising (a) a bottom part for mounting to a roof area of a vehicle and (b) a top part movable relative to the bottom part for opening and closing the roof box, the top part comprising (i) a first polymeric wall and a second polymeric wall defining an interior space therebetween, and (b) at least one strengthening element each comprising a respective portion of the first polymeric wall joined to a respective portion of the second polymeric wall and being surrounded by the interior space.

The invention also provides a roof box comprising: (a) a bottom part comprising a bottom section and side sections projecting upwardly from the bottom section, the bottom section being adapted for mounting the roof box to a roof area of a vehicle; (b) a top part movable relative to the bottom part between an opened position and a closed position, the top part comprising a top section and side sections projecting downwardly from the top section, wherein, in the closed position, the bottom section and the side sections of the bottom part and the top section and the side sections of the top part define an internal volume for storing objects in the roof box, the top part comprising first and second polymeric walls joined together at the side sections of the top part to define an interior space between the first and second polymeric walls; and (c) at least one strengthening element provided in the top section of the top part, each strengthening element being made of a respective portion of the first polymeric wall fused to a corresponding portion of the second polymeric wall and extending longitudinally along the roof box.

The invention further provides a roof box comprising (a) a bottom part for mounting to a roof area of a vehicle and (b) a top part movable relative to the bottom part for opening and closing the roof box, the bottom part and the top part defining a volume for storing objects in the roof box when the roof box is closed, the roof box being adapted to provide an extension unit defining an internal space that is additional to the volume.

The invention also provides a roof box comprising (a) a bottom part for mounting to a roof area of a vehicle, (b) a top part movable relative to the bottom part for opening and closing the roof box, the bottom part and the top part defining a volume for storing objects in the roof box when the roof box is closed, and (c) at least one partition movable relative to the bottom part and adapted to define a plurality of compartments in the volume. The roof box may comprise a plurality of partitions, each of the partitions being adapted to separate adjacent ones of the compartments. Each of the at least one partition may be pivotable relative to the bottom part. Alternatively, each of the at least one partition may be slidable relative to the bottom part.

These and other aspects and features of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 diagrammatically illustrates a roof box for a vehicle, in accordance with an embodiment of the invention;

FIG. 2 is a perspective view of the roof box shown in FIG. 1;

FIG. 3 is a perspective view of the roof box shown in FIG. 1 in which the roof box is opened;

FIG. 4 is a side elevation view of the roof box shown in FIG. 1;

FIG. 5 is a rear elevation view of the roof box shown in FIG. 1;

FIG. 6 is a top plan view of the roof box shown in FIG. 1;

FIG. 7 is an enlarged perspective view of part of the roof box shown in FIG. 1;

FIGS. 8A to 8C diagrammatically illustrate cross-sections of walls of a top part and a bottom part of the roof box shown in FIG. 1;

FIGS. 9A to 9F diagrammatically illustrate part of a process for manufacturing the top part of the roof box shown in FIG. 1;

FIG. 10 is a perspective view of a variant of the roof box shown in FIG. 1;

FIG. 11 is another perspective view of the roof box shown in FIG. 10; and

FIGS. 12A and 12B are perspective views of another variant of the roof box shown in FIG. 1.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

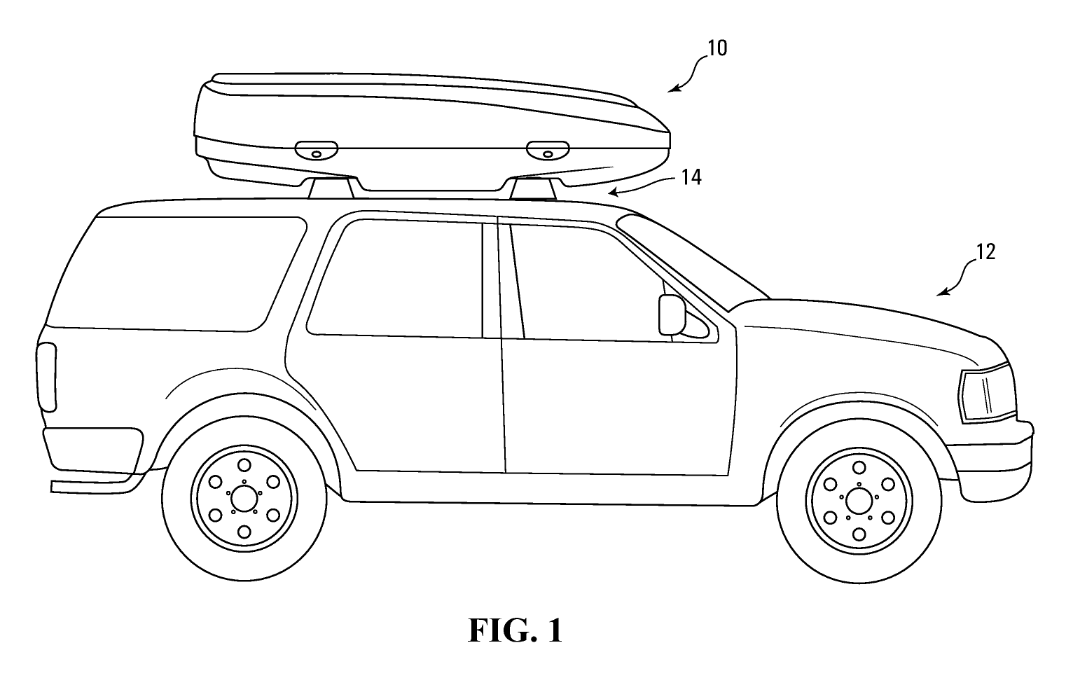

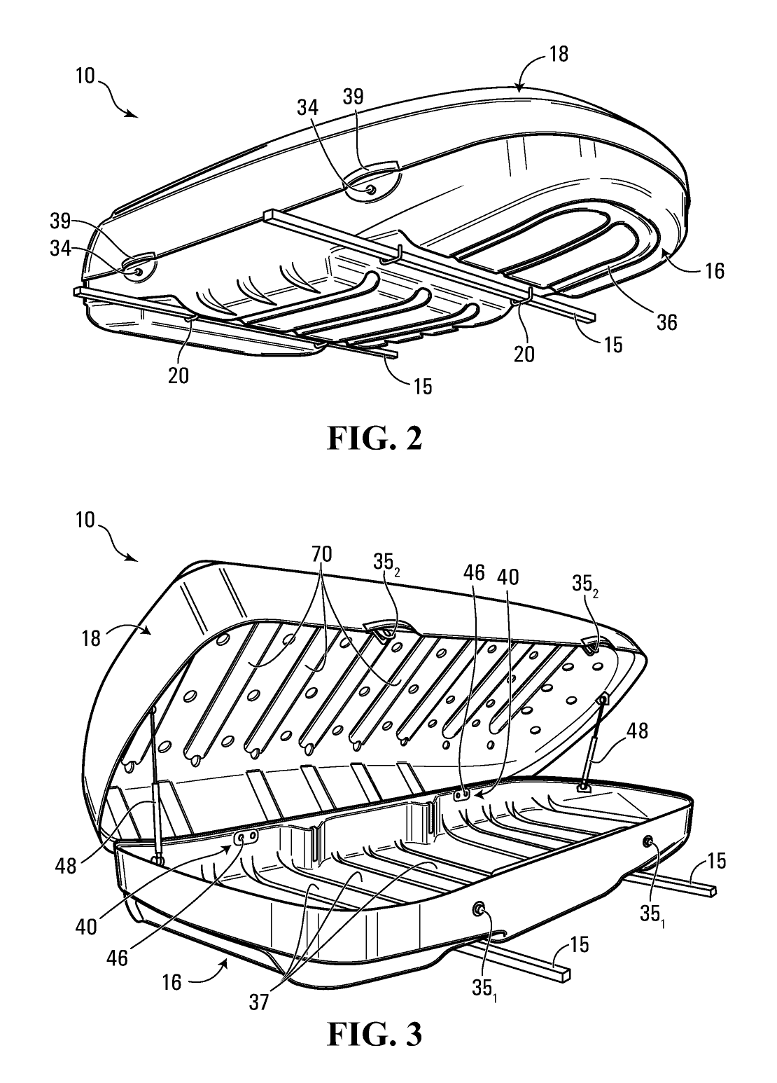

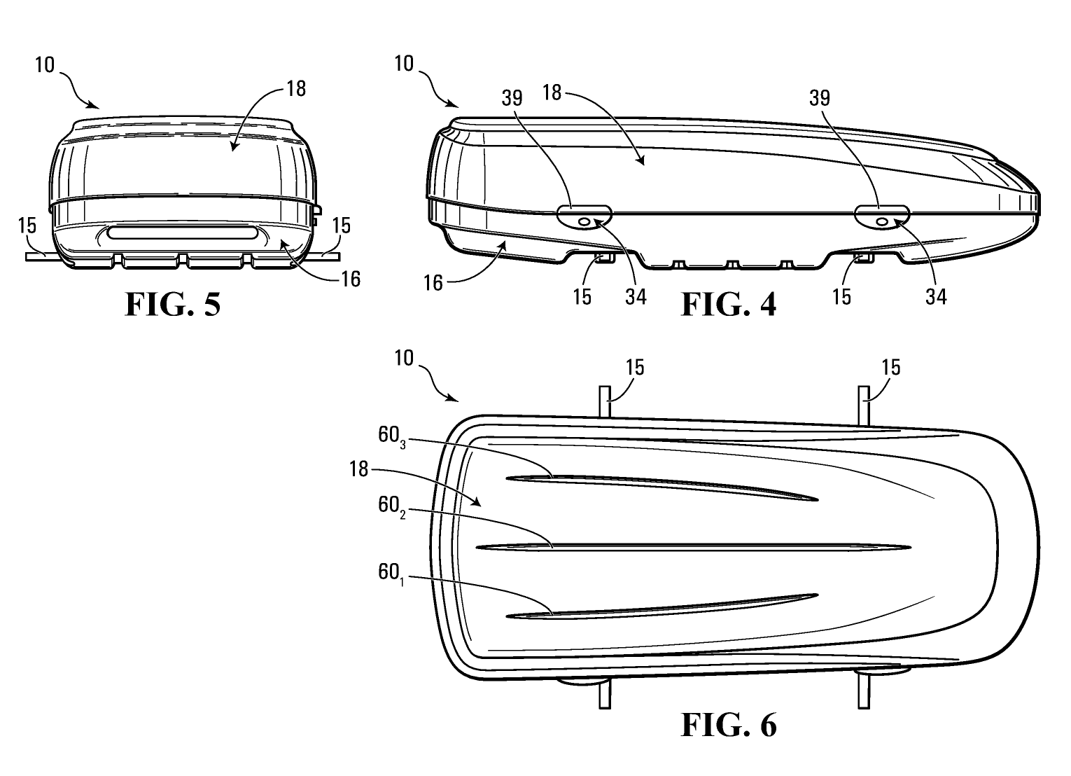

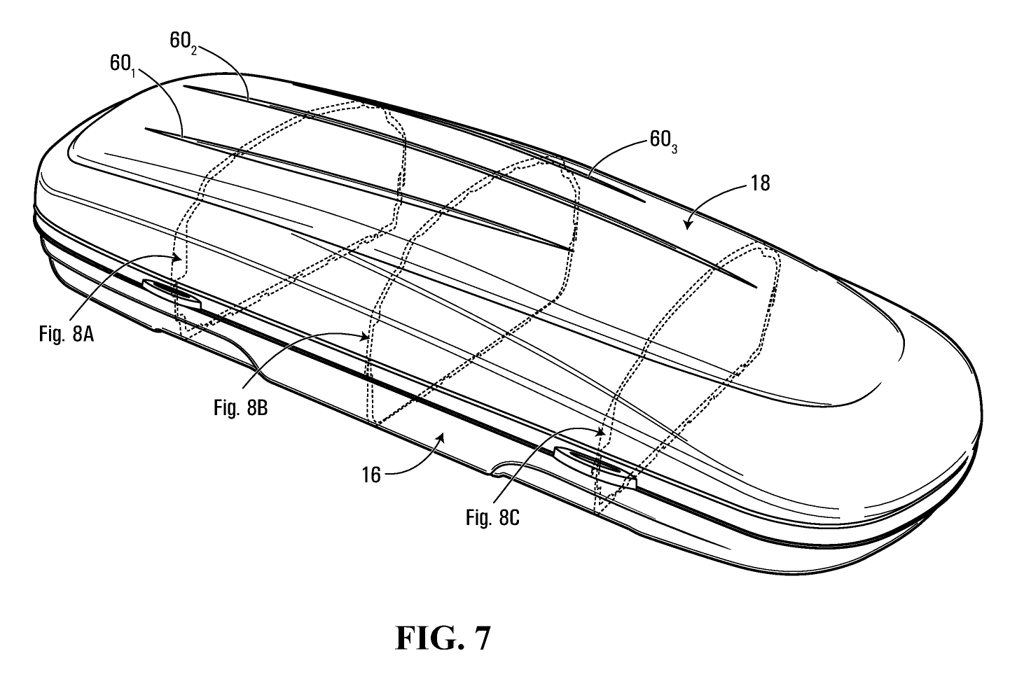

FIGS. 1 to 7 show a roof box 10 for a vehicle 12, in accordance with an embodiment of the invention. The roof box 10 is a container mountable to a roof area 14 of the vehicle 12 and adapted to store luggage, cargo and/or other objects (e.g., sporting equipment). The roof box 10 comprises a bottom part 16 and a top part 18.

The bottom part 16 is configured as a receptacle base for receiving luggage, cargo and/or other objects to be stored in the roof box 10. The bottom part 16 is adapted to be mounted to the roof area 14 of the vehicle 12. More particularly, the bottom part 16 is adapted to be mounted to a rack or other structure 15 of the roof area 14 of the vehicle 12. In this embodiment, the bottom part 16 is provided with mounting holes that enable use of mounting units 20 for mounting the bottom part 16 to the rack or other structure 15 of the roof area 14. For example, each mounting unit 20 may comprise a fastening arrangement that may comprise a U-bolt or other type of bolts, nuts and possibly other structural elements (e.g., one or more bearing plates, brackets, washers, etc.). As another example, each mounting unit 20 may comprise a clamp mechanism or any other mechanism for securing the bottom part 16 to the rack or other structure 15 of the roof area 14. In other embodiments, the bottom part 16 may be provided with other types of mounting units without being provided with mounting holes.

The roof box 10 may comprise locking units 34 for locking the roof box 10 when it is closed. The bottom part 16 is provided with a respective first locking part 35₁ of each locking unit 34. The first locking part 35₁ of each locking unit 34 is adapted to interact with a second locking part 35₂ of that locking unit which is provided on the top part 18 in order to lock the roof box 10 when it is closed. This enables a user to selectively lock and unlock the roof box 10 when it is closed, for example, by operating a key or inputting a combination associated with each locking unit 34. The top part 18 may also be provided with handles 39 to facilitate opening and closing of the roof box 10.

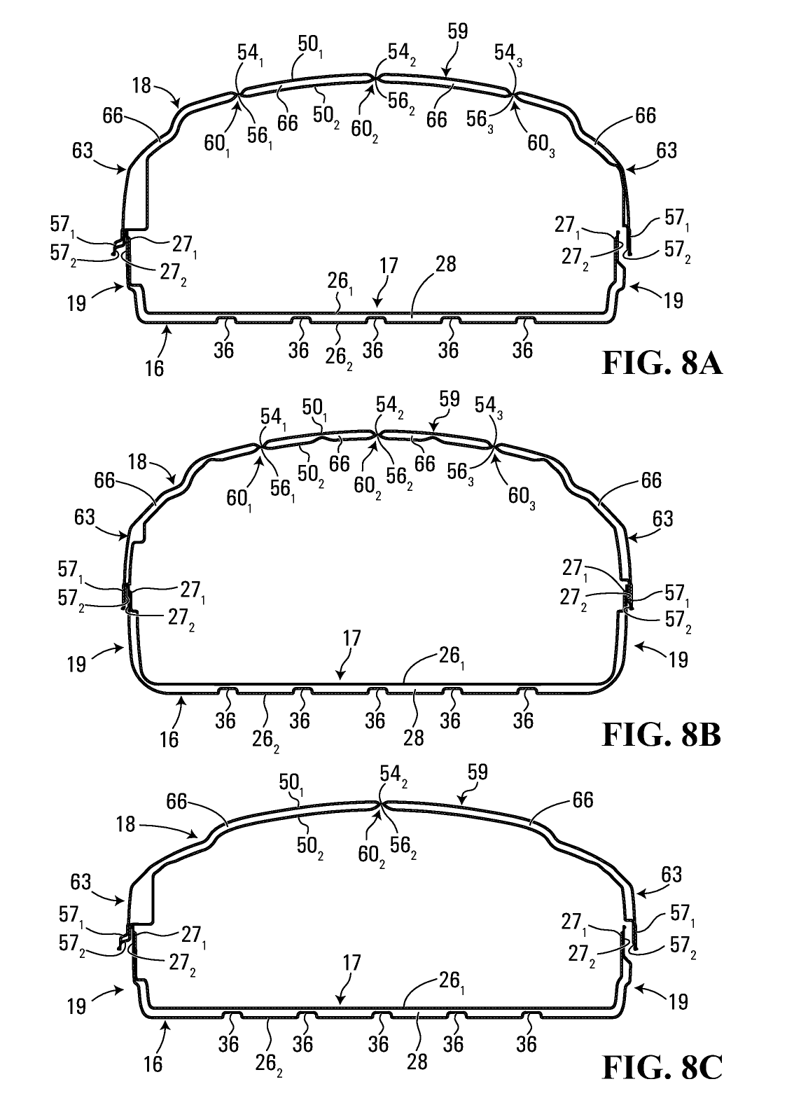

As shown in FIGS. 8A to 8C, in this embodiment, the bottom part 16 comprises a first wall 26₁ and a second wall 26₂ that define an interior space 28. The first wall 26₁ is a first thermoformed sheet of polymeric material having a first peripheral portion 27₁ and the second wall 26₂ is a second thermoformed sheet of polymeric material having a second peripheral portion 27₂. The first peripheral portion 27₁ and the second peripheral portion 27₂ are joined together so as to form the interior space 28.

Examples of polymeric material that may be used include high molecular weight polyethylene or any other suitable plastic material. In one embodiment, and as described later on, the first wall 26₁ and the second wall 26₂, may be thermoformed via a twin-sheet forming process. In such an embodiment, the peripheral portion 27₁ of the first wall 26₁ and the peripheral portion 27₂ of the second wall 26₂ may be fused together.

In this embodiment, the bottom part 16 has a central bottom section 17 that is substantially horizontal and side sections 19 that project upwardly from the central bottom section 17.

The second wall 26₂ may comprise a plurality of grooves 36 extending toward the first wall 26₁ and extending substantially longitudinally along the bottom part 16. The grooves 36 may enhance structural rigidity of the bottom part 16. Also, when luggage, cargo and/or other objects are stored in the roof box 10, their weight may cause a downward deflection of the first wall 26₁ in which case one or more of the grooves 36 of the second wall 26₂ may limit the downward deflection by providing abutment surfaces. The grooves 36 may also enhance aesthetics of the bottom part 16.

As shown in FIG. 3, the first wall 26₁ may also comprise a plurality of depressions 37 extending substantially transversely of the bottom part 16. The depressions 37 may enhance structural rigidity of the bottom part 16. Also, when luggage, cargo and/or other objects are stored in the roof box 10, one or more of the depressions 37 may assist in retaining in place these stored objects. The depressions 37 may also enhance aesthetics of the bottom part 16.

Although this embodiment depicts one possible configuration and size for the bottom part 16, in other embodiments, the bottom part 16 may have various other configurations and sizes.

Referring to FIGS. 1 to 7, the top part 18 is configured as a lid that cooperates with the bottom part 16 to define a volume for storing luggage, cargo and/or other objects in the roof box 10 when it is closed. The top part 18 also provides protection of objects stored in the roof box 10 against exposure to adverse weather and environment conditions (e.g., wind, rain, snow, UV radiation, etc.) and against theft and/or vandalism.

The top part 18 is movable relative to the bottom part 16 for opening and closing the roof box 10. In this embodiment, movement of the top part 18 relative to the bottom part 16 is enabled by the top part 18 being hingedly connected to the bottom part 16.

For example, the top part 18 and the bottom part 16 may be connected via a hinge connection 40 on one side of the roof box 10. The hinge connection 40 may comprise a lateral part of the top part 18 overlapping a lateral part of the bottom part 16 and coupled thereto by fasteners 46. Various other types of hinge connections may be used in other embodiments. Also, although in this embodiment the top part 18 is movable relative to the bottom part 16 for opening and closing the roof box 10 from only one side of the roof box 10, in other embodiments, the top part 18 may be movable relative to the bottom part 16 for opening and closing the roof box 10 from either side of the roof box 10.

The roof box 10 may comprise support members 48 respectively located at a front end and a rear end of the roof box 10 and coupled to the bottom part 16 and the top part 18. The support members 48 contribute to stabilizing the top part 18 when it is moved relative to the bottom part 16 in order to open or close the roof box 10. The support members 48 may also restrict movement of the top part 18 relative to the bottom part 16 so as to limit an extent of opening of the roof box 10. Each support member 48 may comprise a cylinder pivotally coupled to the bottom part 16 and a rod pivotally coupled to the top part 18 and adapted to move within the cylinder. Various other types of support members are possible and may be used in other embodiments.

As shown in FIGS. 8A to 8C, the top part 18 comprises a first wall 50₁ and a second wall 50₂ that define an interior space 66. The first wall 50₁ is a first thermoformed sheet of polymeric material having a first peripheral portion 57₁ and the second wall 50₂ is a second thermoformed sheet of polymeric material having a second peripheral portion 57₂. The first peripheral portion 57₁ and the second peripheral portion 57₂ are joined together so as to form the interior space 66.

Examples of polymeric material that may be used include high molecular weight polyethylene or any other suitable plastic material. In this embodiment, and as described later on, the first wall 50₁ and the second wall 50₂, may be thermoformed via a twin-sheet forming process. In this case, the first peripheral portion 50₁ and the second peripheral portion 57₂ may be fused together.

In this embodiment, the top part 18 has a central top section 59 that is substantially horizontal and side sections 63 that project downwardly from the central top section 59.

The top part 18 comprises a plurality of strengthening elements 60₁ . . . 60₃ that enhance rigidity and strength characteristics of the top part 18. Each of the strengthening elements 60₁ . . . 60₃ comprises a respective portion 54ⱼ of the first wall 50₁ joined to a respective portion 56ⱼ of the second wall 50₂ (where j=1, 2 or 3). In embodiments where the first wall 50₁ and the second wall 50₂ are thermoformed via a twin-sheet forming process, the respective portion 54ⱼ of the first wall 50₁ of each of the strengthening elements 60₁ . . . 60₃ may be fused to the respective portion 56ⱼ of the second wall 50₂ of that strengthening element.

In this embodiment, the respective portion 54ⱼ of the first wall 50₁ of each of the strengthening elements 60₁ . . . 60₃ is a groove extending towards the second wall 50₂, and the respective portion 56ⱼ of the second wall 50₂ of that strengthening element is a groove extending towards the first wall 50₁. In other embodiments, the respective portion 54ⱼ of the first wall 50₁ and the respective portion 56ⱼ of the second wall 50₂ of each of the strengthening elements 60₁ . . . 60₃ may have various other configurations.

Each of the strengthening elements 60₁ . . . 60₃ is surrounded by the interior space 66.

That is, each of the strengthening elements 60₁ . . . 60₃ has at least two sides each facing a respective portion of the interior space 66. Also, the strengthening elements 60₁ . . . 60₃ are remote from the first peripheral portion 57₁ and the second peripheral portion 57₂ so as to enhance rigidity and strength characteristics of the top part 18.

More specifically, while the strengthening elements 60₁ . . . 60₃ are provided in the central top section 59 of the top part 18, the first peripheral portion 57₁ and the second peripheral portion 57₂ are part of the side sections 63 of the top part 18.

Each of the strengthening elements 60₁ . . . 60₃ may extend substantially longitudinally along the top part 18. Various other configurations and orientations are possible in other embodiments. Also, it is to be understood that the top part 18 may comprise one or more strengthening elements configured and located to enhance rigidity and strength characteristics of the top part 18.

It will thus be appreciated that the strengthening elements 60₁ . . . 60₃ enhance rigidity and strength characteristics of the top part 18. Furthermore, since they comprise respective portions of the first wall 50₁ and the second wall 50₂ of the top part 18 that are joined together, the strengthening elements 60₁ . . . 60₃ may be formed directly during thermoforming of the top part 18 without requiring introduction of separate strengthening inserts between the first wall 50₁ and the second wall 50₂, thereby facilitating manufacturing of the top part 18. In addition, the strengthening elements 60₁ . . . 60₃ may enhance aesthetic aspects of the top part 18.

As shown in FIG. 3, the second wall 50₂ may also comprise a plurality of projections 70 projecting away from the first wall 50₁ and extending substantially transversely of the top part 18. The projections 70 may further contribute to enhancing structural rigidity of the top part 18. The projections 70 may also enhance aesthetics of the top part 18.

While this embodiment depicts one possible configuration and size for the top part 18, in other embodiments, the top part 18 may have various other configurations and sizes.

It will thus be appreciated that the roof box 10 provides convenient means for storing luggage, cargo and/or other objects on the roof area 14 of the vehicle 12. It will also be appreciated that various modifications of and enhancements to the roof box 10 may be made in other embodiments.

For example, in some embodiments, the first wall 26₁ and the second wall 26₂ of the bottom part 16 may be joined to form one or more strengthening elements such as the strengthening elements 60₁ . . . 60₃ in order to enhance rigidity and strength characteristics of the bottom part 16.

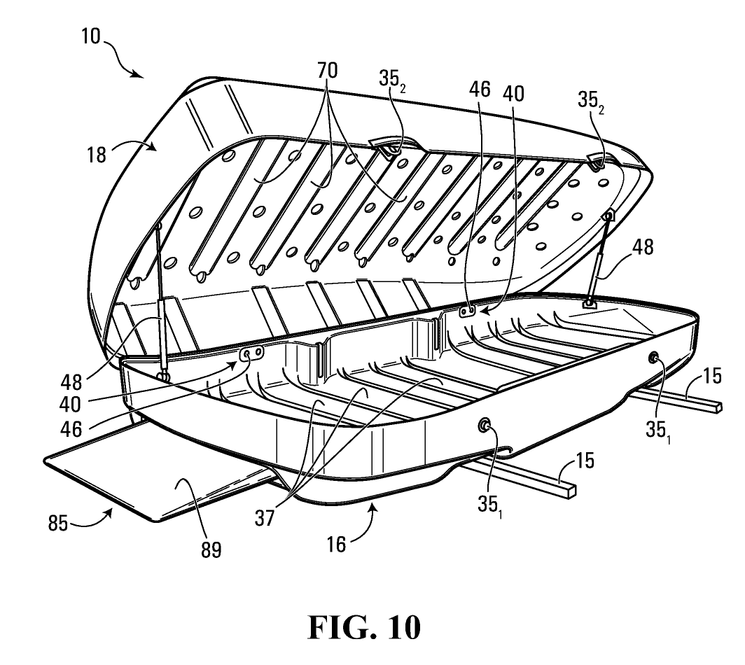

As another example, in some embodiments, the roof box 10 may be provided with features enabling accommodation of different storage requirements. FIGS. 10, 11, 12A and 12B illustrate embodiments in which the roof box 10 is provided with examples of such features that enable adaptability of the roof box 10 by enabling a user to selectively reconfigure the roof box 10 to facilitate storage of different objects therein.

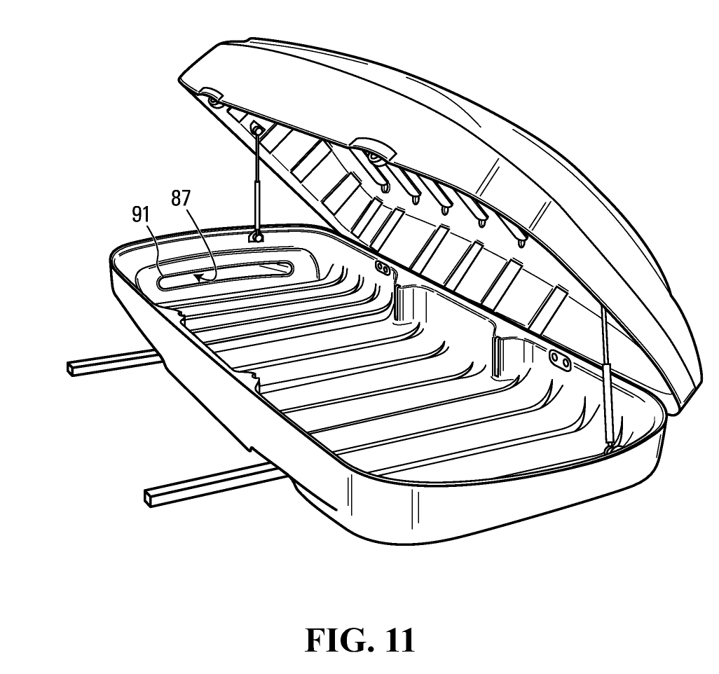

In the embodiment shown in FIGS. 10 and 11, the roof box 10 is adapted to provide an extension unit 85. The extension unit 85 defines an internal space 87 that is additional to the volume defined by the bottom part 16 and the top part 18 for storing luggage, cargo and/or other objects in the roof box 10 when it is closed. This enables the roof box 10 to store additional objects and/or certain objects that it may otherwise not be able to store (e.g., objects having dimensions preventing them from being stored in the roof box 10 without the extension unit 15 such as skis, etc.).

In this embodiment, the extension unit 85 is located at the rear end of the roof box 10 and extends longitudinally thereof. In this case, the extension unit 85 comprises an elongated body 89 that defines the internal space 87 and that is made of a rigid material such as a polymeric material. Examples of polymeric material that may be used include high molecular weight polyethylene or any other suitable plastic material. The elongated body 89 is adapted to extend through and outwardly away from an aperture (not shown) defined by the bottom part 16 and has an end portion 91 adapted to engage an internal surface of the bottom part 16 around the aperture in order to retain the elongated body 89 with the bottom part 16. A cover element (not shown) adapted to be coupled to the bottom part 16 may be used to close or cover the aperture when the extension unit 85 is not used. In other embodiments, the extension unit 85 may be held on the roof box 10 by fasteners, quick-connect mechanisms, and/or various other means.

The extension unit 85 may be implemented in various other manners in other embodiments. For example, in some embodiments, the extension unit 85 may comprise a flexible element coupled to the bottom part 16 and adapted to flexibly extend outwardly from the bottom part 16. The flexible element may comprise a piece of flexible material such as a fabric or an elastic material. In other embodiments, the extension unit 85 may comprise an arrangement of telescopic elements coupled to the bottom part 16, the telescopic elements being adapted to telescopically extend outwardly from the bottom part 16. Also, the extension unit 85 may be located at various other locations in other embodiments. For example, in some embodiments, the extension unit 85 may be located on one side of the roof box 10 and extend laterally thereof.

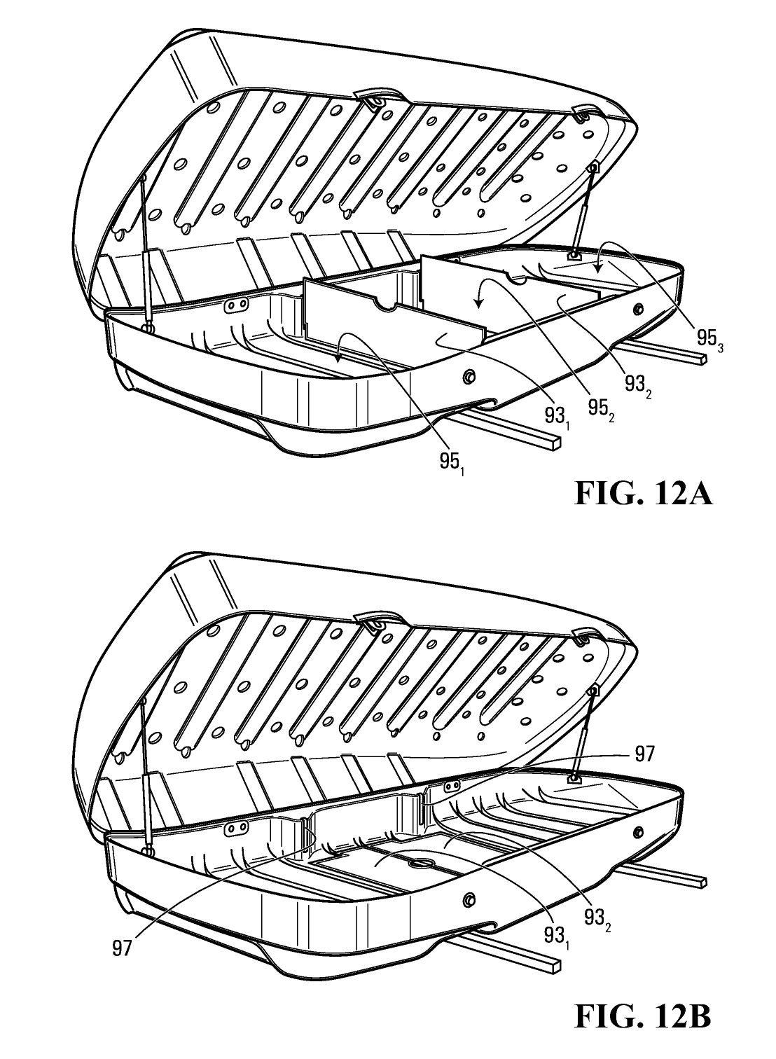

In the embodiment shown in FIGS. 12A and 12B, the roof box 10 comprises a first partition 93₁ and a second partition 93₂ that are movable to define a plurality of compartments 95₁ . . . 95₃. Each of the first partition 93₁ and the second partition 93₂ is adapted to separate adjacent ones of the compartments 95₁ . . . . 95₃. The first partition 93₁ and the second partition 93₂ thus enable compartmentalization of the volume defined by the bottom part 16 and the top part 18 for storing luggage, cargo and/or other objects in the roof box 10. This enables storage of different objects in different ones of the compartments 95₁ . . . 95₃, for example, in situations where it may be desired to store certain objects separate from other objects. This also enables storage of one or more objects in a particular one of the compartments 95₁ . . . 95₃ so as to limit potential movement of the one or more objects within the roof box 10 due to motion of the vehicle 12.

In this embodiment, each of the first partition 93₁ and the second partition 93₂ is pivotable relative to the central bottom section 17 of the bottom part 16 between a first position and a second position. In the first position, which is shown in FIG. 12A, each of the first partition 93₁ and the second partition 93₂ defines adjacent ones of the compartments 95₁ . . . 95₃. Each of the first partition 93₁ and the second partition 93₂ may be manually pivoted into the first position and held in that position by fitting its extremities into respective grooves 97 provided in the bottom part 16. In the second position, which is shown in FIG. 12B, each of the first partition 93₁ and the second partition 93₂ lays down on the central bottom section 17 of the bottom part 16 and does not define any compartments. It will be appreciated that each of the first partition 93₁ and the second partition 93₂ may independently be in the first position or the second position. As shown in FIG. 12B, when both the first partition 93₁ and the second partition 93₂ are in the second position, the volume defined by the bottom part 16 and the top part 18 is not compartmentalized.

Each of the first partition 93₁ and the second partition 93₂ may be movable in various other manners in other embodiments. For example, in some embodiments, each of the first partition 93₁ and the second partition 93₂ may be slidable into the respective grooves 97 provided in the bottom part 16 so as to define adjacent ones of the compartments 95₁ . . . 95₃. In such embodiments, each of the first partition 93₁ and the second partition 93₂ may be removed altogether from the roof box 10 and slid into position when desired.

Each of the first partition 93₁ and the second partition 93₂ may be made of a polymeric material such as high molecular weight polyethylene or any other suitable plastic material.

While in this embodiment the roof box 10 comprises two partitions capable of forming two or three compartments, in other embodiments, the roof box 10 may comprise one or more partitions capable of forming two or more compartments.

It will be appreciated that, in some embodiments, the roof box 10 may be provided with an extension unit such as the extension unit 85 described above in connection with FIGS. 10 and 11, as well as one or more partitions such as the first partition 93₁ and the second partition 93₂ described above in connection with FIGS. 12A and 12B. It will also be appreciated that a roof box may be provided with an extension unit such as the extension unit 85 and/or one or more partitions such as the first partition 93₁ and the second partition 93₂, without comprising a top part or a bottom part that comprises first and second walls defining an interior space (such as the top part 18 of the roof box 10).

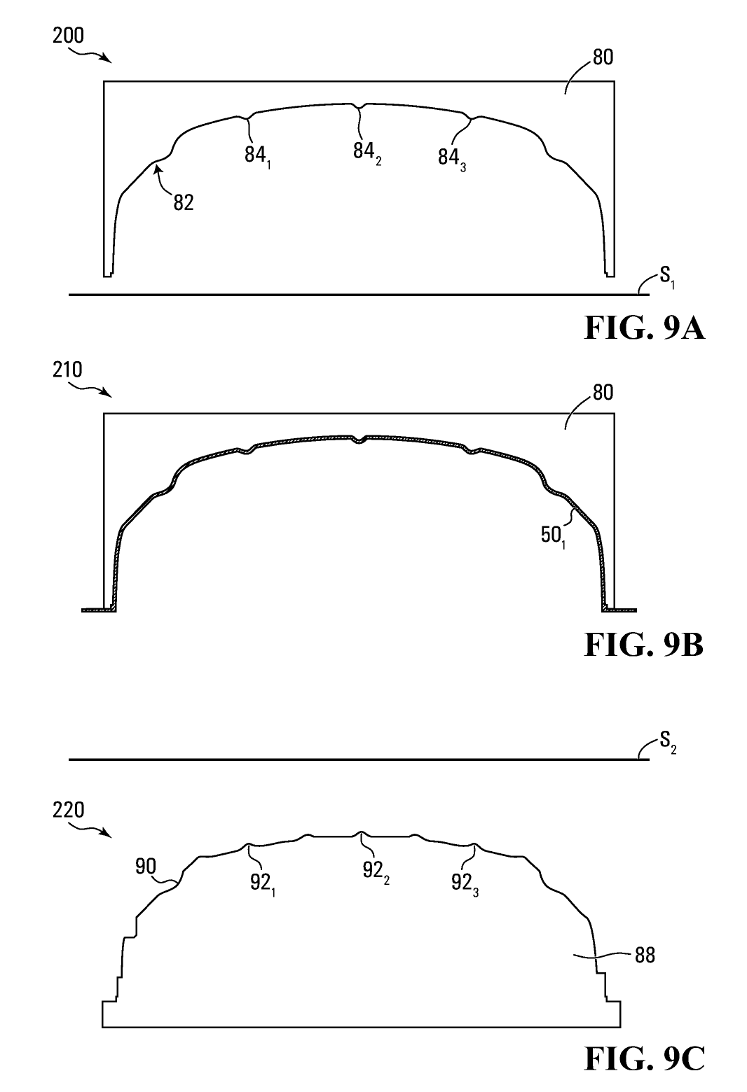

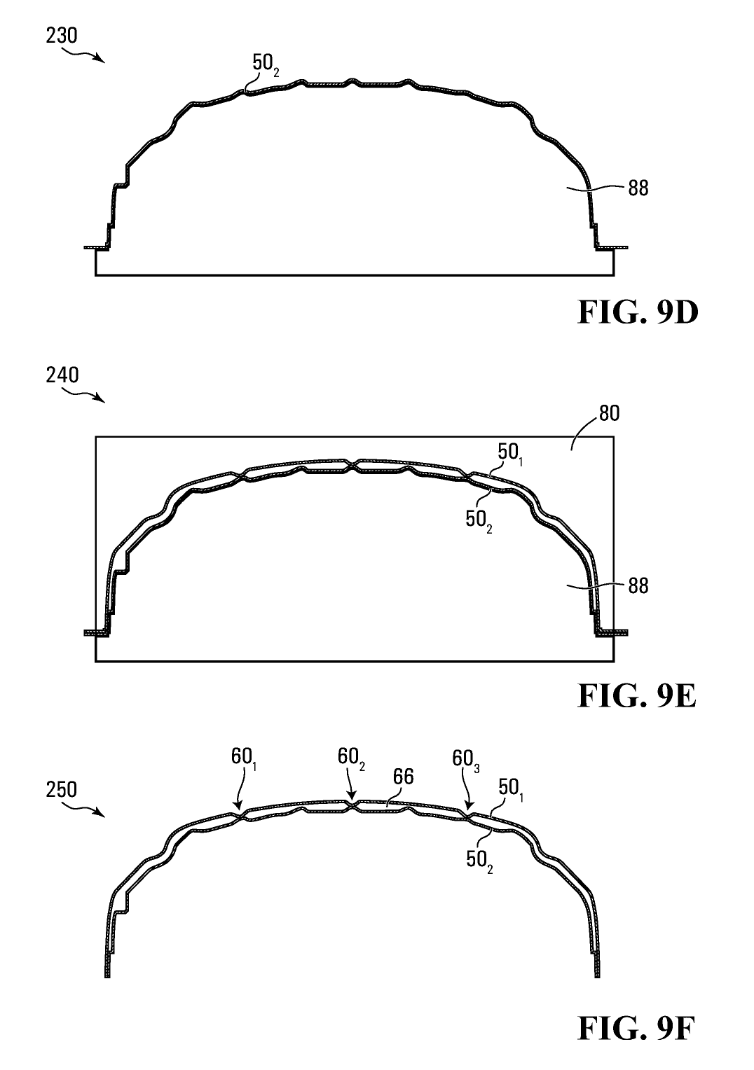

Turning now to FIGS. 9A to 9F, there is diagrammatically shown part of a process for manufacturing the top part 18 of the roof box 10.

At step 200, a first sheet of polymeric material S₁ heated to a forming temperature is held (e.g., clamped) and positioned adjacent to a first mold 80. The first mold 80, which in this case is a female mold, comprises a molding surface 82 configured to impart a desired configuration to the first sheet of polymeric material S₁. In particular, the molding surface 82 has a plurality of projections 84₁ . . . 84₃ each intended to form a respective portion of the first sheet of polymeric material S₁ that will eventual form part of one of the strengthening elements 60₁ . . . 60₃ of the top part 18 (i.e., the respective portion 54ⱼ of the first wall 50₁ of one of the strengthening elements 60₁ . . . 60₃).

At step 210, the first mold 80 is moved relative to the first sheet of polymeric material S₁ such that the first sheet of polymeric material S₁ is forced against the molding surface 82. This results in thermoforming of the first sheet of polymeric material S₁ and production of the first wall 50₁ of the top part 18. In some embodiments, the first mold 80 may be heated to enable proper thermoforming of the first sheet of polymeric material S₁.

At step 220, a second sheet of polymeric material S₂ heated to a forming temperature is held (e.g., clamped) and positioned adjacent to a second mold 88. The second mold 88, which in this case is a male mold, comprises a molding surface 90 configured to impart a desired configuration to the second sheet of polymeric material S₂. In particular, the molding surface 90 has a plurality of projections 92₁ . . . 92₃ each intended to form a respective portion of the second sheet of polymeric material S₂ that will eventual form part of one of the strengthening elements 60₁ . . . 60₃ of the top part 18 (i.e., the respective portion 56ⱼ of the second wall 50₂ of one of the strengthening elements 60₁ . . . 60₃).

At step 230, the second mold 88 is moved relative to the second sheet of polymeric material S₂ such that the second sheet of polymeric material S₂ is forced against the molding surface 90. This results in thermoforming of the second sheet of polymeric material S₂ and production of the second wall 50₂ of the top part 18. In some embodiments, the second mold 88 may be heated to enable proper thermoforming of the second sheet of polymeric material S₂.

At step 240, the first mold 80 and the second mold 88 are pressed against each other. Temperature and pressure conditions result in the first peripheral portion 57₁ of the first wall 50₁ and the second peripheral portion 57₂ of the second wall 50₂ being fused to each other. These conditions also result in the respective portion 54ⱼ of the first wall 50₁ of each of the strengthening elements 60₁ . . . 60₃ being fused to the respective portion 56ⱼ of the second wall 50₂ of that strengthening element, thereby effectively forming the strengthening elements 60₁ . . . 60₃.

At step 250, the first mold 80 and the second mold 88 are separated. A trimming or deburring operation is performed to remove extraneous edge portions of the first sheet of polymeric material S₁ and the second sheet of polymeric material S₂. The first wall 50₁ and the second wall 50₂ of the top part 18 are obtained, with the strengthening elements 60₁ . . . 60₃ that enhance rigidity and strength characteristics of the top part 18 having been formed directly during thermoforming without requiring introduction of separate strengthening inserts between the first wall 50₁ and the second wall 50₂.

With respect to manufacturing of the bottom part 16, it will be appreciated that, in some embodiments, a thermoforming process similar to that described above in connection with the top part 18 may be used.

Other processing operations are performed to complete the roof box 10. For example, processing operations are performed to couple together the top part 18 and the bottom part 16 and to provide the locking units 34, the support members 48 and possibly other components of the roof box 10.

It is to be understood that the above-described process is presented for example purposes only as various other processes may be used to manufacture a roof box such as the roof box 10.

Although various embodiments and examples have been presented, this was for the purpose of describing, but not limiting, the invention. Various modifications and enhancements will become apparent to those of ordinary skill in the art and are within the scope of the present invention, which is defined by the attached claims.

1. A roof box comprising (a) a bottom part for mounting to a roof area of a vehicle and (b) a top part movable relative to said bottom part for opening and closing said roof box, said top part comprising (i) a first polymeric wall and a second polymeric wall defining an interior space therebetween, and (ii) at least one strengthening element each comprising a respective portion of said first polymeric wall joined to a respective portion of said second polymeric wall and being surrounded by said interior space.

2. A roof box as claimed in claim 1, wherein said respective portion of said first polymeric wall of each of said at least one strengthening element is fused to said respective portion of said second polymeric wall of said strengthening element.

3. A roof box as claimed in claim 1, wherein said at least one strengthening element comprises a plurality of strengthening elements.

4. A roof box as claimed in claim 3, wherein said respective portion of said first polymeric wall of each of said strengthening elements is fused to said respective portion of said second polymeric wall of said strengthening element.

5. A roof box as claimed in claim 1, wherein said first polymeric wall is a first thermoformed sheet of polymeric material having a first peripheral portion and said second polymeric wall is a second thermoformed sheet of polymeric material having a second peripheral portion, said first peripheral portion and said second peripheral portion being joined together so as to form said interior space, said at least one strengthening element being remote from said first peripheral portion and said second peripheral portion.

6. A roof box as claimed in claim 5, wherein said respective portion of said first polymeric wall of each of said at least one strengthening element is fused to said respective portion of said second polymeric wall of said strengthening element.

7. A roof box as claimed in claim 1, wherein said top part comprises a top section and side sections projecting downwardly from said top section, said at least one strengthening element being located in said top section.

8. A roof box as claimed in claim 1, wherein each of said at least one strengthening element extends substantially longitudinally along said top part.

9. A roof box as claimed in claim 1, wherein said respective portion of said first polymeric wall of each of said at least one strengthening element is a groove extending towards said second polymeric wall.

10. A roof box as claimed in claim 9, wherein said respective portion of said second polymeric wall of each of said at least one strengthening element is a groove extending towards said first polymeric wall.

11. A roof box as claimed in claim 1, wherein each of said at least one strengthening element is a top strengthening element, said bottom part comprising (a) a first polymeric wall and a second polymeric wall defining an interior space therebetween, and (b) at least one bottom strengthening element each comprising a respective portion of said first polymeric wall of said bottom part joined to a respective portion of said second polymeric wall of said bottom part and being surrounded by said interior space of said bottom part.

12. A roof box as claimed in claim 11, wherein said respective portion of said first polymeric wall of each of said at least one bottom strengthening element is fused to said respective portion of said second polymeric wall of said bottom strengthening element.

13. A roof box as claimed in claim 11, wherein said at least one bottom strengthening element comprises a plurality of bottom strengthening elements.

14. A roof box as claimed in claim 13, wherein said respective portion of said first polymeric wall of each of said bottom strengthening elements is fused to said respective portion of said second polymeric wall of said bottom strengthening element.

15. A roof box as claimed in claim 11, wherein said first polymeric wall of said bottom part is a first thermoformed sheet of polymeric material having a first peripheral portion and said second polymeric wall of said bottom portion is a second thermoformed sheet of polymeric material having a second peripheral portion, said first peripheral portion of said bottom part and said second peripheral portion of said bottom part being joined together so as to form said interior space of said bottom part, said at least one bottom strengthening element being remote from said first peripheral portion of said bottom part and said second peripheral portion of said bottom part.

16. A roof box as claimed in claim 15, wherein said respective portion of said first polymeric wall of each of said at least one bottom strengthening element is fused to said respective portion of said second polymeric wall of said bottom strengthening element.

17. A roof box as claimed in claim 1, wherein said top part is hingedly connected to said bottom part to enable said top part to move relative to said bottom part for opening and closing said roof box.

18. A roof box as claimed in claim 1, wherein said bottom part enables use of mounting units for mounting said bottom part to the roof area of the vehicle.

19. A roof box as claimed in claim 1, wherein said roof box comprises a locking unit for locking said roof box when said roof box is closed.

20. A roof box comprising:
a bottom part comprising a bottom section and side sections projecting upwardly from said bottom section, said bottom section being adapted for mounting said roof box to a roof area of a vehicle;
a top part movable relative to said bottom part between an opened position and a closed position, said top part comprising a top section and side sections projecting downwardly from said top section, wherein, in said closed position, said bottom section and said side sections of said bottom part and said top section and said side sections of said top part define an internal volume for storing objects in said roof box, said top part comprising first and second polymeric walls joined together at said side sections of said top part to define an interior space between said first and second polymeric walls; and
at least one strengthening element provided in said top section of said top part, each strengthening element being made of a respective portion of said first polymeric wall fused to a corresponding portion of said second polymeric wall and extending longitudinally along said roof box.

21. A roof box as claimed in claim 20, wherein said at least one strengthening element comprises a plurality of strengthening elements.

22. A roof box as claimed in claim 21, wherein said top part is hingedly connected to said bottom part.

23. A roof box as claimed in claim 22, wherein said roof box comprises a locking unit for locking said roof box when said top part is in said closed position.

24. A roof box as claimed in claim 20, wherein each of said at least one strengthening element is a top strengthening element, said bottom part comprising (a) a first polymeric wall and a second polymeric wall defining an interior space therebetween, and (b) at least one bottom strengthening element provided in said bottom section of said bottom part, each bottom strengthening element being made of a respective portion of said first polymeric wall of said bottom part fused to a corresponding portion of said second polymeric wall of said bottom part and extending longitudinally along said roof box.

25. A roof box as claimed in claim 20, wherein said first polymeric wall has a first peripheral portion and said second polymeric wall has a second peripheral portion, said first peripheral portion and said second peripheral portion being joined together at said side sections of said top part to define said interior space.

26. A roof box comprising (a) a bottom part for mounting to a roof area of a vehicle and (b) a top part movable relative to said bottom part for opening and closing said roof box, said bottom part and said top part defining a volume for storing objects in said roof box when said roof box is closed, said roof box being adapted to provide an extension unit defining an internal space that is additional to said volume.

27. A roof box as claimed in claim 26, wherein the extension unit is locatable at an end of said roof box so as to extend longitudinally thereof.

28. A roof box as claimed in claim 26, wherein the extension unit comprises an elongated body defining the internal space and made of a rigid material.

29. A roof box as claimed in claim 28, wherein said bottom part defines an aperture, the elongated body being adapted to extend through and outwardly away from said aperture.

30. A roof box as claimed in claim 26, wherein the extension unit comprises a flexible element coupled to one of said bottom part and said top part and adapted to flexibly extend outwardly from said one of said bottom part and said top part.

31. A roof box as claimed in claim 26, wherein the extension unit comprises an arrangement of telescopic elements coupled to one of said bottom part and said top part, said telescopic elements being adapted to telescopically extend outwardly from said one of said bottom part and said top part.
